(19) United States
(12) Patent Application Publication
(10) Pub. No.: US 2017/0201563 A1
(43) Pub. Date: Jul. 13, 2017

(54) VIDEO DATA PROVIDING METHOD, VIDEO PLAYBACK METHOD, DEVICE, AND SYSTEM

(71) Applicant: ZTE CORPORATION, Shenzhen, City (CN)

(72) Inventor: Yi WANG, Shenzhen City (CN)

(73) Assignee: ZTE CORPORATION, Shenzhen City (CN)

(21) Appl. No.: 15/318,112

(22) PCT Filed: Nov. 3, 2014
(86) PCT No.: PCT/CN2014/090181

§ 371 Date: Mar. 23, 2017

(30) Foreign Application Priority Data
Jun. 11, 2014 (CN) 201410257937.7

(51) Int. Cl. H04L 29/06; H04L 12/46

(52) U.S. Cl. CPC H04L 65/601; H04L 12/4641; H04L 65/608; H04L 67/42

(57) ABSTRACT

A video data providing method, a video playback method, apparatus, and system are disclosed. The video data providing method includes: acquiring a video playback instruction coming from a virtual desktop client and transmitting video information corresponding to the video playback instruction to the virtual desktop client; receiving a connection request of the virtual desktop client and establishing a connection with the virtual desktop client; and transmitting video stream data to the virtual desktop client according to a video data request of the virtual desktop client. The methods, apparatus and system reduce the occupation of a CPU of the server by the virtual desktop client during video playback.

### CROSS-REFERENCE TO RELATED APPLICATION

This application is the U.S. national phase of PCT Appln. No. PCT/CN2014/090181 filed Nov. 3, 2014, which claims priority to Chinese Application No. 201410257937.7 filed Jun. 11, 2014, the disclosures of which are incorporated in their entirety by reference herein.

### TECHNICAL FIELD

The present disclosure relates to the communication technology field, and in particular, to a video data providing method, a video playback method, apparatus, and system.

### BACKGROUND

In recent years, the desktop virtualization service began to flourish in China, the operators, universities, governments and enterprises are all gradually adopting the desktop virtualization technology to replace the usage of the traditional Personal Computer (PC). The virtual desktop mainly uses the Virtual Desktop Infrastructure (VDI) technology currently, and the VDI is a server-based computing model, can host and uniformly manage all desktop virtual machines in the data center, store the operating system and the application program into the server and storage device of the data center, establish the virtual machine pool at the background to provide to different end users, and enable the users to obtain a complete PC use experience. When the video is played in the VDI mode currently, the virtual machine uses the player to decode and obtain the video image, and then the Simple Protocol for Independent Computing Environment (SPICE) module at the server end performs encoding process on the image, and transmits the video data after performing encoding on the SPICE client through the SPICE channel, and the SPICE client decodes the video data and the video can be played on the client. In that kind of video processing mode, the encoding and compression work of the video data are mostly completed by the Central Processing Unit (CPU) of the server, and when multiple cloud terminals play the video at the same time, it will lead to higher occupancy rate of the CPU at the server side, and the phenomenon will occur, such as, stuck video image, desynchrony of video sound and video image, etc., to make the whole video playback be not smooth, and restricts the number of the cloud terminals which can be towed by the server at the same time.

### SUMMARY

The technical problem required to be solved by the embodiment of the present disclosure is the problem that when the cloud terminal is used for playing the video in the existing technology, the video decoding and compression are completed by the CPU of the server, resulting in the larger occupancy rate of the CPU of the server.

The embodiment of the present disclosure provides a video data providing method, including: acquiring a video playback instruction from a virtual desktop client and transmitting video information corresponding to the video playback instruction to the virtual desktop client; receiving a connection request of the virtual desktop client and establishing a connection with the virtual desktop client; and transmit video stream data to the virtual desktop client according to a video data request of the virtual desktop client.

Alternatively, the above video information includes: address information of the video stream data in a virtual machine server.

Alternatively, transmitting video information corresponding to the video playback instruction to the virtual desktop client includes: transmitting the video information corresponding to the video playback instruction to the virtual desktop client through a Simple Protocol for Independent Computing Environment, SPICE.

The embodiment of the present disclosure further provides a video playback method, including: transmitting a video playback instruction to a virtual machine server side; receiving video information corresponding to the video playback instruction from the virtual machine server side; establishing a connection with the server side, and transmitting a video data request to the virtual machine server side according to the video information; receiving video stream data from the virtual machine server side, and decoding the video stream data and playing decoded video data.

Alternatively, the above video information includes: address information of the video stream data in a virtual machine server.

The embodiment of the present disclosure further provides a data providing apparatus, including: a first transmission module, arranged to: acquire a video playback instruction from a virtual desktop client and transmit video information corresponding to the video playback instruction to the virtual desktop client; a connection establishment module, arranged to: receive a connection request of the virtual desktop client and establish a connection with the virtual desktop client; a second transmission module, arranged to: transmit video stream data to the virtual desktop client according to a video data request of the virtual desktop client.

Alternatively, the above video information includes: address information of the video stream data in a virtual machine server.

Alternatively, the first transmission module is arranged to: transmit the video information corresponding to the video playback instruction to the virtual desktop client through a Simple Protocol for Independent Computing Environment, SPICE.

The embodiment of the present disclosure further provides a video playback apparatus, including: a third transmission module, arranged to: transmit a video playback instruction to a virtual machine server side; a receiving module, arranged to: receive video information corresponding to the video playback instruction from the virtual machine server side; a fourth transmission module, arranged to: establish a connection with the server side, and transmit a video data request to the virtual machine server side according to the video information; a playback module, arranged to: receive video stream data from the virtual machine server side, decoding the video data and playing decoded video data.

Alternatively, the above video information includes: address information of the video stream data in a virtual machine server.

The embodiment of the present disclosure further provides a video playback system, including above video data providing apparatus and above video playback apparatus.

The embodiment of the present disclosure further provides a computer program, including program instructions, herein, when the program instructions are executed by a computer, the computer is enabled to execute the methods as described above.

The embodiment of the present disclosure further provides a computer readable storage medium including the computer program.

The technical scheme of the embodiment of the present disclosure acquires a video playback instruction from a virtual desktop client and transmits video information corresponding to the video playback instruction to the virtual desktop client; receives the request for reading the video data by the virtual desktop client, provides the video stream data corresponding to the video information for the virtual desktop client, which reduces the occupation of the CPU in the server by the virtual desktop client during video playback.

### BRIEF DESCRIPTION OF DRAWINGS

FIG. 1 is a flow chart of a video data providing method according to an embodiment of the present disclosure;

FIG. 2 is a flow chart of a video playback method according to an embodiment of the present disclosure;

FIG. 3 is a structure block diagram of a video data providing apparatus according to an embodiment of the present disclosure;

FIG. 4 is a structure block diagram of a video playback apparatus according to an embodiment of the present disclosure; and

FIG. 5 is a structure block diagram of a video playback system according to an embodiment of the present disclosure.

### PREFERRED EMBODIMENTS

The implementation of the technical scheme is described in details by combining with the accompanying drawings hereinafter, in the case of not conflicting, the embodiments of the present disclosure and features in these embodiments can be combined with each other at will.

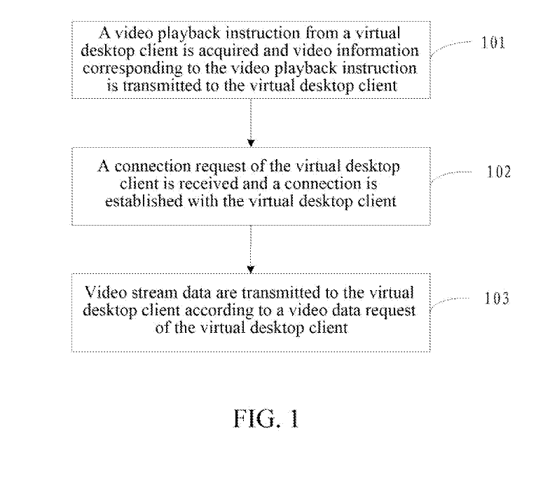

FIG. 1 is a flow chart of a video data providing method according to an embodiment of the present disclosure.

As shown in FIG. 1, the method includes the following steps.

In step 101: a video playback instruction from a virtual desktop client is acquired and video information corresponding to the video playback instruction is transmitted to the virtual desktop client;

The video information can include address information, in the virtual machine server, of the video data corresponding to the video playback instruction. After the client who runs the virtual desktop acquires the address information, the server side can be accessed through the address information to obtain the video data required for playing the video. Alternatively, transmitting video information corresponding to the video playback instruction to the virtual desktop client includes: transmitting the video information corresponding to the video playback instruction to the client through the SPICE protocol; based on that, the communication between the above client and the server side can be performed by using the SPICE protocol.

In step 102: a connection request of the virtual desktop client is received and a connection is established with the virtual desktop client.

In step 103: video stream data are transmitted to the virtual desktop client according to a video data request of the virtual desktop client.

In step 103, the video in a local server of the virtual machine server side is used as the service source of the stream media to provide the video stream data for the virtual desktop client, to run the virtual desktop client for the video playback.

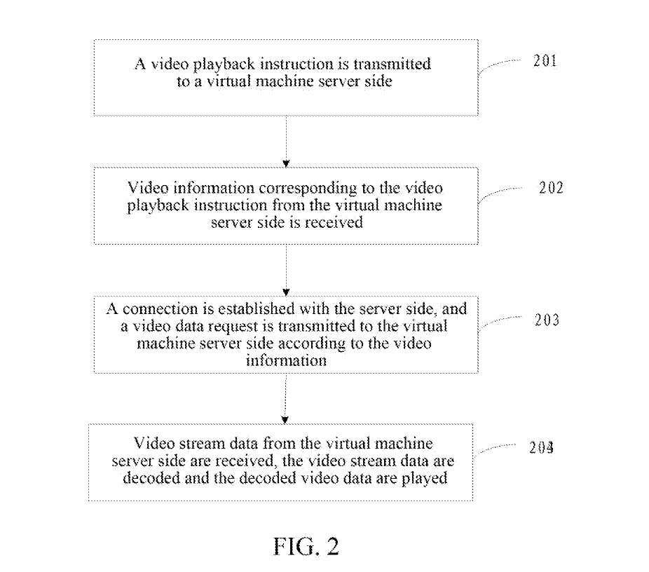

FIG. 2 is a flow chart of a video playback method according to an embodiment of the present disclosure. As shown in FIG. 2, the method includes the following steps.

In step 201: a video playback instruction is transmitted to a virtual machine server side.

In step 201, it can be that, after the user sends the video playback instruction through the operation of the terminal running the virtual desktop client, the virtual desktop client sends the video playback instruction to the virtual machine server side, and the video playback instruction includes identification information of the video to be played.

In step 202: video information corresponding to the video playback instruction from the virtual machine server side is received.

In step 203: a connection is established with the server side, and a video data request is transmitted to the virtual machine server side according to the video information;

In step 204: video stream data from the virtual machine server side are received, the video stream data are decoded and the decoded video data are played.

The video information includes the address information, in the virtual machine server, of the video stream data corresponding to the video playback instruction. The terminal running the virtual desktop can access the server through the address information, to obtain the video stream data required for the video playback.

For the step 203, a module with video decoding function can be set in the client run on the terminal, to realize the decoding of the video data by using the module, that is, the received video stream can be decoded by using the CPU of the client through software, and hand decoding can be also performed on the received video stream also by installing a decoder chip.

The overall processes of the video data providing method and the video playback method of the embodiment of the present disclosure are described based on the SPICE client and the SPICE server side hereinafter.

The software related to the video playback server is installed in the virtual machine desktop, and the decoder chip can also be installed on the terminal;

the user logs in the virtual desktop through the SPICE client, to remotely access the virtual machine, and performs the video playback operation;

a video playback server is started, to acquire relevant information of the video required to be played, and video playback server sends the relevant information of the video to the SPICE client through the SPICE protocol, herein, the relevant information of the video can be specifically the address information of the video;

after the SPICE client receives the relevant information of the video, the video playback module is started and connected to the video playback server to read the video stream data, the read video stream is decoded, and the decoded video data are played.

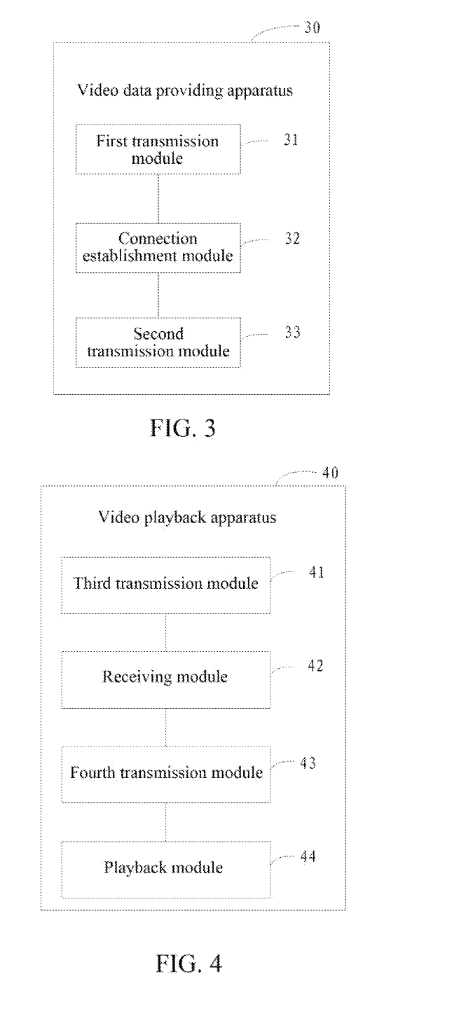

FIG. 3 is a structure block diagram of a video data providing apparatus according to an embodiment of the present disclosure.

As shown in FIG. 3, the apparatus 30 includes the following component parts:

a first transmission module 31, arranged to: acquire a video playback instruction from a virtual desktop client and transmit video information corresponding to the video playback instruction to the virtual desktop client;

a connection establishment module 32, arranged to: receive a connection request of the virtual desktop client and establish a connection with the virtual desktop client;

a second transmission module 33, arranged to: transmit video stream data to the virtual desktop client according to a video data request of the virtual desktop client.

The above video information includes address information of the video data corresponding to the video playback instruction.

The above first transmission module 31 is arranged to: transmit the video information corresponding to the video playback instruction to the virtual desktop client through the SPICE.

FIG. 4 is a structure block diagram of a video playback apparatus according to an embodiment of the present disclosure.

As shown in FIG. 4, the apparatus 40 includes the following component parts: a third transmission module 41, arranged to: transmit a video playback instruction to a virtual machine server side;

a receiving module 42, arranged to: receive video information corresponding to the video playback instruction from the virtual machine server side;

a fourth transmission module 43, arranged to: establish a connection with the server side, and transmit a video data request to the virtual machine server side according to the video information;

a playback module 44, arranged to: receive video stream data from the virtual machine server side, decoding the video stream data and playing decoded video data.

The above video information includes address information of the video data corresponding to the video playback instruction.

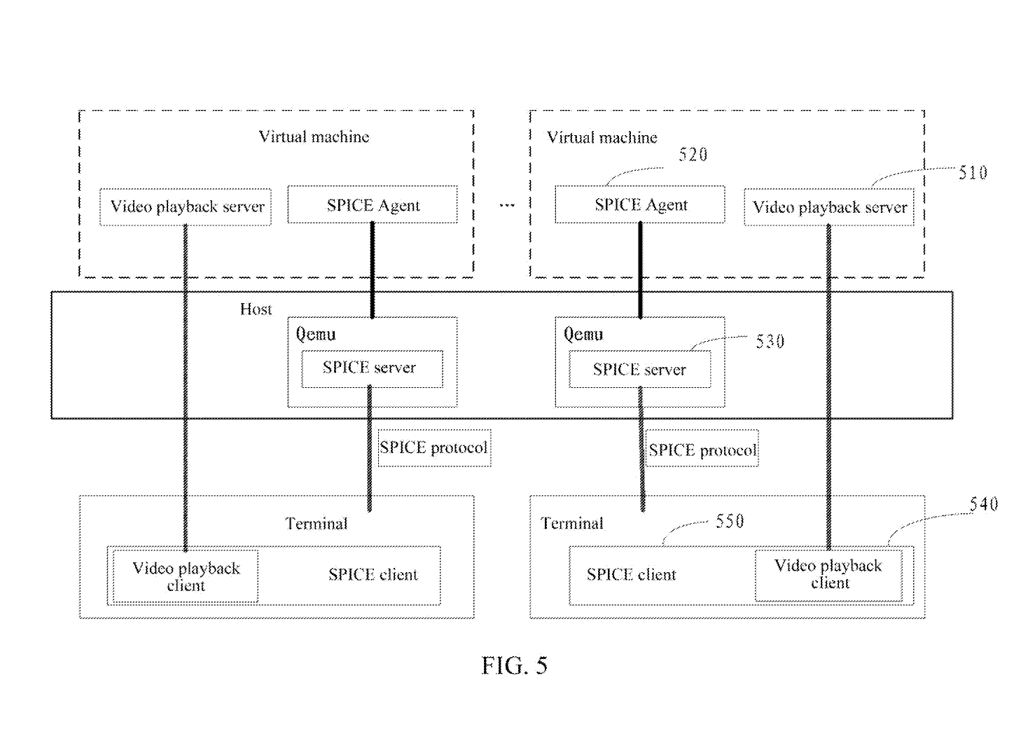

The embodiment of the present disclosure further provides a video playback system, which includes the video data providing apparatus as shown in FIG. 3 and the video playback apparatus as shown in FIG. 4; at the same time, the system can also be realized by using the structure as shown in FIG. 5; as shown in FIG. 5, the system includes the following component parts:

a video playback server side module 510, an SPICE Agent 520, an SPICE server side module 530, a video playback client module 540 and an SPICE client module 550; herein, the functions realized by the two modules, the video playback server side module 510 and the SPICE server side module 530,are equivalent to the functions of the above video data providing apparatus, the functions realized by the video playback client module 540 and the SPICE client module 550 are equivalent to the functions of the above video playback apparatus, and the SPICE Agent 520 is a component running on the virtual desktop, which mainly has the common functions, such as, driver, agency, etc.

The video playback server side module 510 is arranged to manage the video files of the system, when the user clicks the video file through the terminal running the virtual desktop, the module 510 transmits the video information required by video playback through the SPICE server side module 530 to the SPICE client module 550, and the module 550 is used as a server for the video playback client module 540 to connect and read the video data. After the SPICE client module receives the video data of the SPICE server side module 530, the video playback client module 540 is started and connected to the video playback server side module 510, to decode and play the video data.

The video playback scheme based on the virtualization provided by the embodiment of the present disclosure, through using the decoding ability of the terminal, reduces the load of the CPU at the server side, reduces the consumption of the computing resources at the server side, increases the number of the cloud terminals which can be towed by the server, and improves the playback effect of the video in the situation that multiple cloud terminals play the video at the same time.

Through the illustration of the specific embodiments, it should be able to deeply and specifically understand the technical means, adopted by the present disclosure to achieve the intended purpose, and the effects, however, the accompanying figures are only used to provide reference and illustration, which are not used to limit the present disclosure.

It can be understood by those skilled in the art that all or part of steps in the above-mentioned embodiment can be fulfilled by the computer program flow, and the computer program flow can be stored in a computer readable storage medium, and the computer program flow is executed on the corresponding hardware platform (such as a system, a device, an apparatus, a component, etc.), and includes one of the steps of the method embodiment or its combination when being executed.

Alternatively, all or part of the steps in the above-mentioned embodiments also can be implemented by the integrated circuits. Those steps can be made into integrated circuit modules one after another respectively, or multiple modules or steps therein are made into a single integrated circuit module for implementation. This way, the present disclosure is not limit to any specific form of the combination of the hardware and software.

Each device/function module/function unit in the above-mentioned embodiment can be implemented by the universal calculating apparatus, and they can be integrated in a single calculating apparatus, or distributed in the network made up by a plurality of calculating apparatus.

Each device/function module/function unit in the above-mentioned embodiment can be stored in a computer readable storage medium when it is implemented in the form of the software function module and is sold or used as an individual product. The above-mentioned computer readable storage medium can be a read only memory, a magnetic disk or an optical disk, etc.

Those modifications and replacements which can be thought out easily by those skilled in the art in the technical scope disclosed by the present disclosure should be embodied in the protection scope of the present disclosure. Therefore, the protection scope of the present disclosure should be based on the protection scope described by the claims.

### INDUSTRIAL APPLICABILITY

The technical scheme of the embodiment of the present disclosure acquires a video playback instruction from a virtual desktop client and transmits video information corresponding to the video playback instruction to the virtual desktop client; receives the request for reading the video data by the virtual desktop client, provides the video stream data corresponding to the video information for the virtual desktop client, which reduces the occupation of a CPU of the server by the virtual desktop client during video playback.

1. A video data providing method, comprising:
acquiring a video playback instruction from a virtual desktop client and transmitting video information corresponding to the video playback instruction to the virtual desktop client;
receiving a connection request of the virtual desktop client and establishing a connection with the virtual desktop client; and
transmitting video stream data to the virtual desktop client according to a video data request of the virtual desktop client.

2. The method according to claim 1, wherein, the video information comprises: address information of the video stream data in a virtual machine server.

3. The method according to claim 1, wherein, transmitting video information corresponding to the video playback instruction to the virtual desktop client comprises:
transmitting the video information corresponding to the video playback instruction to the virtual desktop client through a Simple Protocol for Independent Computing Environment SPICE.

4. A video playback method, comprising:
transmitting a video playback instruction to a virtual machine server side;
receiving video information corresponding to the video playback instruction from the virtual machine server side;
establishing a connection with the server side, and transmitting a video data request to the virtual machine server side according to the video information; and
receiving video stream data from the virtual machine server side, decoding the video stream data and playing decoded video data.

5. The method according to claim 4, wherein, the video information comprises: address information of the video stream data in a virtual machine server.

6. A video data providing apparatus, comprising:
a first transmission module, arranged to: acquire a video playback instruction from a virtual desktop client and transmit video information corresponding to the video playback instruction to the virtual desktop client;
a connection establishment module, arranged to: receive a connection request of the virtual desktop client and establish a connection with the virtual desktop client; and
a second transmission module, arranged to: transmit video stream data to the virtual desktop client according to a video data request of the virtual desktop client.

7. The apparatus according to claim 6, wherein, the video information comprises: address information of the video stream data in a virtual machine server.

8. The apparatus according to claim 6, wherein, the first transmission module is arranged to:
transmit the video information corresponding to the video playback instruction to the virtual desktop client through a Simple Protocol for Independent Computing Environment SPICE.

9. A video playback apparatus, comprising:
a third transmission module, arranged to: transmit a video playback instruction to a virtual machine server side;
a receiving module, arranged to: receive video information corresponding to the video playback instruction from the virtual machine server side;
a fourth transmission module, arranged to: establish a connection with the server side, and transmit a video data request to the virtual machine server side according to the video information; and
a playback module, arranged to: receive video stream data from the virtual machine server side, decode the video data and play decoded video data.

10. The apparatus according to claim 9, wherein, the video information comprises: address information of the video stream data in a virtual machine server.

11. A video playback system, comprising a video data providing apparatus of claim 6, and a video playback apparatus, wherein the video playback apparatus comprises:
a third transmission module, arranged to: transmit a video playback instruction to a virtual machine server side;
a receiving module, arranged to: receive video information corresponding to the video playback instruction from the virtual machine server side;
a fourth transmission module, arranged to: establish a connection with the server side, and transmit a video data request to the virtual machine server side according to the video information; and
a playback module, arranged to: receive video stream data from the virtual machine server side, decode the video data and play decoded video data.

12. A computer program, comprising program instructions, wherein, when the program instructions are executed by a computer, the computer is enabled to execute the method of claim 1.

13. A computer readable storage medium comprising a computer program of claim 12.
